(19) United States
(12) Patent Application Publication
(10) Pub. No.: US 2003/0218635 A1
(43) Pub. Date: Nov. 27, 2003

(54) Method and apparatus for displaying and exploring controlled vocabulary data

(76) Inventor: Songqiao Liu, Los Angeles, CA (US)

Correspondence Address: Marvin H. Kleinberg, KLEINBERG & LERNER, LLP, Suite 1080, 2049 Century Park East, Los Angeles, CA, 90067, US

(21) Appl. No.: 10/387,683

(22) Filed: Mar. 12, 2003

Related U.S. Application Data
(60) Provisional application No. 60/363,895, filed on Mar. 12, 2002.

(51) Int. Cl. G09G 5/00

(52) U.S. Cl. 345/804

(57) ABSTRACT

An element of a graphical user interface for displaying and exploring controlled vocabulary data, includes a first display pane for displaying controlled vocabulary terms, a toolbar adjacent to the first display pane containing graphic control elements for manipulating and exploring the controlled vocabulary data, a second display pane adjacent to the first display pane for displaying detailed information concerning at least one selected term of the controlled vocabulary and a third display pane adjacent to the first display pane for providing an interactive means for utilizing controlled vocabulary terms to search a data repository and further including a means for two letter index searching of terms within the controlled vocabulary.

### CROSS-REFERENCE TO RELATED APPLICATIONS

The present application is a continuation in part of U.S. provisional patent application serial No. 60/363,895, which is incorporated into the present application by this reference.

### BACKGROUND

1. Field of the Invention

The present invention relates to the field of controlled vocabularies, and more particularly to a method and apparatus which can be used to display and explore controlled vocabulary data.

2. Prior Art

A controlled vocabulary is tool which can be used in fields that have a need to describe numerous and various items in a precise and exact manner. For example, a controlled vocabulary can be used by a museum to index the objects in its collection. A controlled vocabulary identifies terms used in a particular field or area, and defines relationships between the terms. A controlled vocabulary does not contain all possible terms that may be used in a particular field. Instead, a controlled vocabulary is a limited set of relevant terms that are used in a given field.

A major purpose of a controlled vocabulary is to match the terms brought to the system by a researcher with the terms used by an indexer. Whenever there are alternative names for a type of item, a indexer will have to choose one to use for indexing, and provide an entry under each of the others saying what the preferred term is. For example, a controlled vocabulary for a library may index all full-length works of fiction as “novels”. Then, someone who searches for “mysteries” must be told that they should look for “novels” instead. This is no problem if the two words are really synonyms, and even if they do differ slightly in meaning it may still be preferable to choose one and index everything under that. The controlled vocabulary will therefore indicate synonyms for the relevant terms. Because terms in the controlled vocabulary are used to describe items, they are sometimes referred to as descriptors.

A controlled vocabulary will also describe other types of relationships between words. For example, a controlled vocabulary will often organize terms in a hierarchical format. The term “novels” in the present example, can be a subset of the term “works of fiction” (which might also include “poems” and “short stories”). Thus, the controlled vocabulary will specify where in the hierarchy the terms fall. Broader terms and narrower terms can be specified. Other types of relationships can also be specified by the controlled vocabulary.

It is therefore a goal of the present invention to provide means for displaying and exploring controlled vocabulary data in a manner which permits a user to easily navigate the vocabulary, to view the detailed information concerning a particular term and to understand how terms in the controlled vocabulary relate to each other.

### SUMMARY OF THE INVENTION

The present invention overcomes the limitations of the prior art by providing a method and apparatus for displaying and exploring controlled vocabulary data. A display window in a graphical user interface for displaying and exploring controlled vocabulary data includes a first display pane for displaying controlled vocabulary terms, a toolbar adjacent to the first display pane containing graphic control elements for manipulating and exploring the controlled vocabulary data, a second display pane adjacent to the first display pane for displaying detailed information concerning at least one selected term of the controlled vocabulary and a third display pane adjacent to the first display pane for providing an interactive means for utilizing controlled vocabulary terms to search a data repository. The display window further includes a means for two letter index searching of terms within the controlled vocabulary.

### BRIEF DESCRIPTION OF THE DRAWINGS

FIG. 1 is a block diagram showing a general purpose computer system which can implement the method of the present invention.

FIG. 2 illustrates a display window of a graphical user interface which is used to display terms of a controlled vocabulary.

FIG. 3 illustrates a portion of the display window of FIG. 2 which can be used to search long lists of controlled vocabulary data.

### DETAILED DESCRIPTION OF THE INVENTION

A method and apparatus for displaying and exploring controlled vocabulary data will be described. In the following description, specific method steps and procedures are described in order to give a more thorough understanding of the present invention. In other instances, well known elements such as the operating system and specific software functions are not described in detail so as not to obscure the present invention unnecessarily.

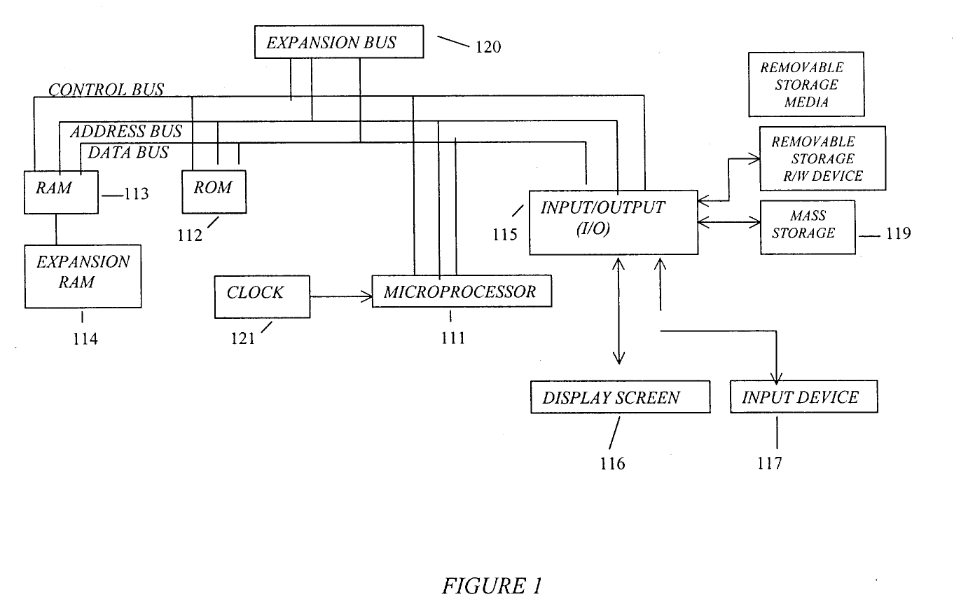

Referring first to FIG. 1, a block diagram of a general purpose computer system which can be used to implement the method of the present invention is illustrated. Specifically, FIG. 1 shows a general purpose computer system 150 for use in practicing the present invention. As shown in FIG. 1, computer system 110 includes a central processing unit (CPU) 111, read-only memory (ROM) 112, random access memory (RAM) 113, expansion RAM 145, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The controlled vocabulary data which is stored in the present invention will be generally stored on mass storage device 119.

In operation, information is input into the computer system 110 by typing on a keyboard, manipulating a mouse or trackball, or “writing” on a tablet or on a position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system or web server. Various other types of computers, however, may be used depending upon the size and complexity of the required tasks. Suitable computers include mainframe computers, multiprocessor computers and workstations. Typically, the program of the present invention will be stored on mass storage device 119 until a user of the computer system 111 initiates its operation. Portions of the program may then be transferred to RAM 113 while the program executes. Alternatively, the program of the present invention may reside in RAM 113 or ROM 112.

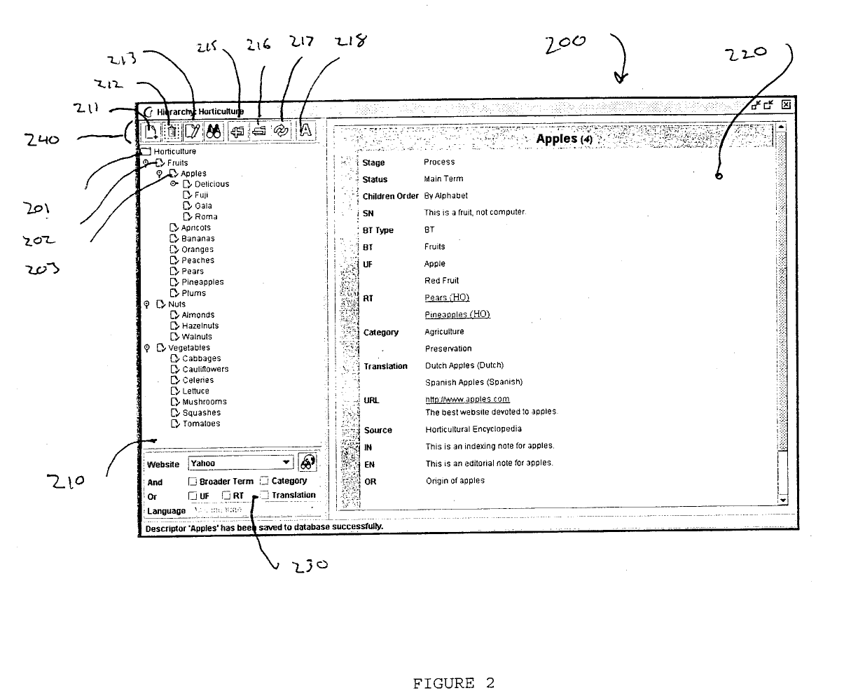

Referring next to FIG. 2, a display window in a graphical user interface (GUI) on the display device of the computer system which incorporates a method of displaying and exploring controlled vocabulary data is illustrated. As shown in FIG. 2, the display window 200 consists of four major different regions 210, 220, 230 and 240. Each performs different functions with regard to the display and exploration of controlled vocabulary data. Appropriate programming instructions (which are well known to those of skill in the art) are used to generate the display window 200.

The various elements of the display window 200 and their various functions will now be described. Display pane 210 is used to display the controlled vocabulary terms 201, 202, 203, etc. In the usual case, the terms of the controlled vocabulary are logically organized into a hierarchical structure. Thus, FIG. 2 shows the controlled vocabulary terms displayed in the same hierarchical manner in display pane 210. The controlled vocabulary terms are not limited to being displayed in the hierarchical format. In an alternative embodiment, the terms are organized alphabetically. Other arrangements can be used with equal effectiveness, such as string length or chronologically (e.g., by date of creation).

A user of the system can navigate through the hierarchy by using standard interface tools for the GUI, such as cursor keys or a pointing device. The user can explore the controlled vocabulary data by moving through the hierarchy. This permits the user to select terms of interest in the controlled vocabulary.

Suitable icons are provided on the toolbar 240 to permit manipulation of the controlled vocabulary data. For example, toolbar 240 includes buttons to generate a new descriptor 211, and to delete 212 or edit 213 an existing descriptor. Icons are also provided to permit the user to change the display of the controlled vocabulary data. A user can expand the hierarchy tree (or a portion thereof) using the expand button 216 or collapse it using the collapse button 216. The controlled vocabulary data can be refreshed using the refresh button 217. The controlled vocabulary can be changed from hierarchical to alphabetical format using button 218. The programming steps which are used to create the functionality of these icons are well known to those of skill in the art.

Display pane 220 permits detailed information concerning a selected controlled vocabulary term to be displayed. The detailed information is automatically retrieved by the computer system whenever the user selects a term in display pane 210. A method of retrieving controlled vocabulary data in the form of thesaurus data which is used in the present invention is described in co-pending patent application Ser. No. ______, assigned to the assignee of the present invention. This arrangement allows the user to navigate vocabularies and view the detailed information of the current descriptor simultaneously. As the user navigates the hierarchy tree, he always knows where a particular descriptor is in the tree and what information it contains at the same time.

The display window 200 also contains a search pane 230 which enables the user to utilize the controlled vocabulary to perform a search of a data repository (such as the Internet) with greater precision and accuracy. A system and method for internet search using controlled vocabulary data which is used in the present invention is described in co-pending patent application Ser. No. ______, assigned to the assignee of the present invention.

FIG. 2 illustrates the major elements 210, 220, 230 and 240 of the display window arranged in a specific format. It will be apparent to those of skill in the art that the specific sizes, shapes and arrangements of the elements of the display window 200 can vary from what is illustrated in FIG. 2. In addition, specific elements, such as the toolbar 240 or the search pane 230 may be eliminated or hidden without departing from the overall spirit and scope of the present invention. All that is necessary is that the display window 200 provides a means for displaying and manipulating the controlled vocabulary data as described above.

The preferred embodiment of the present invention also includes a means for searching long lists of controlled vocabulary data. In particular, the present invention provides a means for searching and browsing a list of controlled vocabulary terms which are arranged in an alphabetical format.

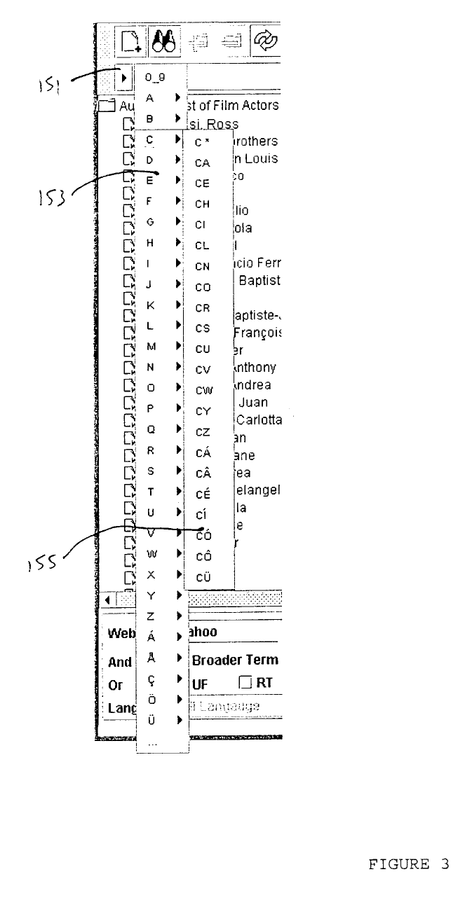

Referring next to FIG. 3, there is shown an index button 151 which is provided in the GUI whenever a long list of controlled vocabulary data is displayed in an alphabetical format. Clicking on the index button activates the index pop-up menu 153. The index pop-up menu 153 uses an approach similar to dictionaries. It is more efficient because it uses a two-level index. Terms in the long list of controlled vocabulary data are arranged by two alphabetical letters. Numeric and special characters can also be used if they are in the controlled vocabulary, as shown in FIG. 2. The pop-up menu 153 lists the first letters (or other character) of all of the terms in the controlled vocabulary. Selecting any character on index pop-up menu 153 activates a second pop-up menu 155. In the example of FIG. 2, the letter “C” has been selected on pop-up menu 153. The user can then select any second character on pop-up menu 155 to obtain a list of all terms in the controlled vocabulary which begin with the two specified characters. The pop-up menus 153 and 155 are dynamically generated and include only those indexes that have data. As a result, the menu is always kept as short as possible and every mouse click by the user will produce results. A means for conducting Boolean keyword searches is also provided.

The preferred embodiment of the present invention utilizes a two-character index for the pop-up menus 153 and 155. It will be apparent to those of skill in the art that a greater number of characters may be provided if desired.

Accordingly, a method and apparatus for displaying and exploring controlled vocabulary data has been described. It is to be understood that the foregoing description has been made with respect to specific embodiments thereof for illustrative purposes only. The overall scope of the present invention is limited only by the following claims.

What is claimed is:

1. A display window in a graphical user interface for displaying and exploring controlled vocabulary data, comprising:
(a) a first display pane for displaying controlled vocabulary terms;
(b) a toolbar adjacent to at least said first display pane, said toolbar containing graphic control elements for manipulating and exploring the controlled vocabulary data;
(c) a second display pane adjacent to at least said first display pane for displaying detailed information concerning at least one selected controlled vocabulary term; and
(d) a third display pane adjacent to at least said first display pane for providing an interactive means for utilizing controlled vocabulary terms to search a data repository.

2. The device of claim 1 wherein said first display pane displays said controlled vocabulary data in a hierarchical format.

3. The device of claim 1 wherein said first display pane displays said controlled vocabulary data in an alphabetical format.

4. The device of claim 1 wherein said data repository comprises the Internet.

5. A search menu in a graphical user interface on a computer system for searching long lists of controlled vocabulary terms, comprising:
a first pop-up menu containing the first characters of all of the terms in the controlled vocabulary
a plurality of second pop-up menus, said second pop-up menus being activated when a character on said first pop-up menu is selected;
wherein said first and second pop-up menus together act as a two-letter index to the terms in the controlled vocabulary.
